(19) United States
(12) Patent Application Publication
(10) Pub. No.: US 2008/0054787 A1
(43) Pub. Date: Mar. 6, 2008

(54) OPTICAL PLATE AND DISPLAY DEVICE HAVING THE SAME

(75) Inventors: Seong-yong HWANG, Seongnam-si (KR); Ju-young YOON, Seoul (KR); Jin-soo KIM, Seoul (KR); Hyoung-joo KIM, Uiwang-si (KR); Gi-cherl KIM, Yongin-si (KR); Eun-jeong KANG, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/847,408

(22) Filed: Aug. 30, 2007

(30) Foreign Application Priority Data
Aug. 30, 2006 (KR) 1020060083074
Feb. 12, 2007 (KR) 1020070014314

(51) Int. Cl. H01J 1/62; G02B 27/00

(52) U.S. Cl. 313/483; 359/619

(57) ABSTRACT

An optical plate includes a plate body, a first lens pattern which is depressed on a first surface of the plate body, and a second lens pattern which is projected from a second surface of the plate body. The second lens pattern corresponds to the first lens pattern.

### CROSS-REFERENCE TO RELATED APPLICATIONS

This application claims priority to Korean Patent Application No. 10-2007-0014314, filed on Feb. 12, 2007 and Korean Patent Application No. 10-2006-0083074, filed on Aug. 30, 2006 and all the benefits accruing therefrom under 35 U.S.C. §119, the contents of which are incorporated herein by reference in their entireties.

### BACKGROUND OF INVENTION

1. Field of Invention

Apparatuses and methods consistent with the present invention relate an optical plate and a display device having the same.

2. Description of the Related Art

A flat panel display device such as a liquid crystal display (“LCD”) device, a plasma display panel (“PDP”), an organic light emitting diode (“OLED”), etc. has been widely developed.

An LCD device includes an LCD panel and a backlight unit. The LCD panel does not emit light by itself, and the backlight unit provides light to the LCD panel.

The backlight unit may be either an edge type or a direct type according to a position of a light source. In the direct type backlight unit, more than one light source is disposed behind the LCD panel and emits light to essentially an entire area of the LCD panel. The direct type backlight unit includes an optical plate and an optical film which are disposed between the light source and the LCD panel. The optical plate and the optical film change characteristics of light provided from the light source and provide light to the LCD panel.

A point light source, such as a light emitting diode (“LED”), has been used as a light source of a backlight unit. However, when the point light source is used, an area of the LCD panel which corresponds to the point light source is bright, while an area between point light sources is dark. Accordingly, brightness becomes non-uniform.

### BRIEF SUMMARY OF THE INVENTION

An exemplary embodiment provides an optical plate which is improved in brightness uniformity.

An exemplary embodiment provides a liquid crystal display (“LCD”) device including an optical plate which is improved in brightness uniformity.

In an exemplary embodiment, an optical plate includes a plate body, a first lens pattern which is depressed on a first surface of the plate body, and a second lens pattern which is projected from a second surface of the plate body. The second lens pattern corresponds to the first lens pattern.

In an exemplary embodiment, a longitudinal cross-section of the first lens pattern is a part of a first oval having a minor axis which is parallel with the fist surface of the plate body.

In an exemplary embodiment, a longitudinal cross-section of the second lens pattern is a part of a second oval having a major axis which is parallel with the second surface of the plate body.

In an exemplary embodiment, a depth of the first lens pattern is about 33% to about 43% of a major radius of the first oval.

In an exemplary embodiment, a minor radius of the first oval is about 40% to about 60% of the major radius of the first oval.

In an exemplary embodiment, a minor radius of the second oval is about 13% to about 23% of the major radius of the first oval.

In an exemplary embodiment, a minor radius of the second oval is about 10% to about 50% of a major radius of the second oval.

In an exemplary embodiment, an area of the first lens pattern is smaller than and included within an area of the second lens pattern.

An exemplary embodiment of a liquid crystal display device includes a liquid crystal display panel, a light source disposed behind the liquid crystal display panel and including a plurality of light emitting diodes, and an optical plate disposed between the liquid crystal display panel and the light source. The optical plate includes a plate body, a first lens pattern depressed on a first surface of the plate body, the first surface of the plate body facing the light source, and a second lens pattern projected from a second surface of the plate body and corresponding to the first lens pattern, the second surface of the plate body facing the liquid crystal display panel.

In an exemplary embodiment, a longitudinal cross-section of the first lens pattern is a part of a first oval.

In an exemplary embodiment, the first oval has a minor axis which is parallel with the first surface of plate body.

In an exemplary embodiment, a depth of the first lens pattern is about 33% to about 43% of a major radius of the first oval.

In an exemplary embodiment, a longitudinal cross-section of the second lens pattern is a part of a second oval.

In an exemplary embodiment, the second oval has a major axis which is parallel with the second surface of the plate body.

In an exemplary embodiment, a minor radius of the first oval is about 40% to about 60% of the major radius of the first oval.

In an exemplary embodiment, a minor radius of the second oval is about 13% to about 23% of the major radius of the first oval.

In an exemplary embodiment, the minor radius of the second oval is about 10% to about 50% of a major radius of the second oval.

In an exemplary embodiment, an area of the first lens pattern is included within an area of the second lens pattern.

In an exemplary embodiment, the first lens pattern is disposed in a matrix form.

In an exemplary embodiment, the first lens pattern is arranged in a plurality of rows and adjacent rows of the first lens pattern are disposed staggered.

In an exemplary embodiment, the first lens pattern is disposed more densely at an area of the optical plate corresponding to the light emitting diodes.

In an exemplary embodiment, the minor axis of the first oval is disposed between the optical plate and the light emitting diodes.

In an exemplary embodiment, the optical plate includes acrylic material.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is an exploded perspective view of an exemplary embodiment of an LCD device according to the present invention;

FIG. 2 is a perspective view of an exemplary embodiment of a back side of an optical plate in the LCD device of FIG. 1 according to the present invention;

FIG. 3 is a cross-section view of the optical plate taken along line III-III in FIG. 1;

FIG. 4 is an enlarged view of portion A in FIG. 3;

FIG. 5 illustrates an exemplary embodiment of a path of light in the LCD device according to the present invention;

FIG. 6 illustrates an exemplary embodiment of a result of brightness uniformity according to a shape of the optical plate;

FIG. 7 is a perspective view of another exemplary embodiment of a back side of an optical plate in an LCD device according to the present invention; and

FIG. 8 is a perspective view of another exemplary embodiment of a back side of an optical plate in an LCD device according to the present invention.

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below so as to explain the present invention by referring to the figures.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below”, “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

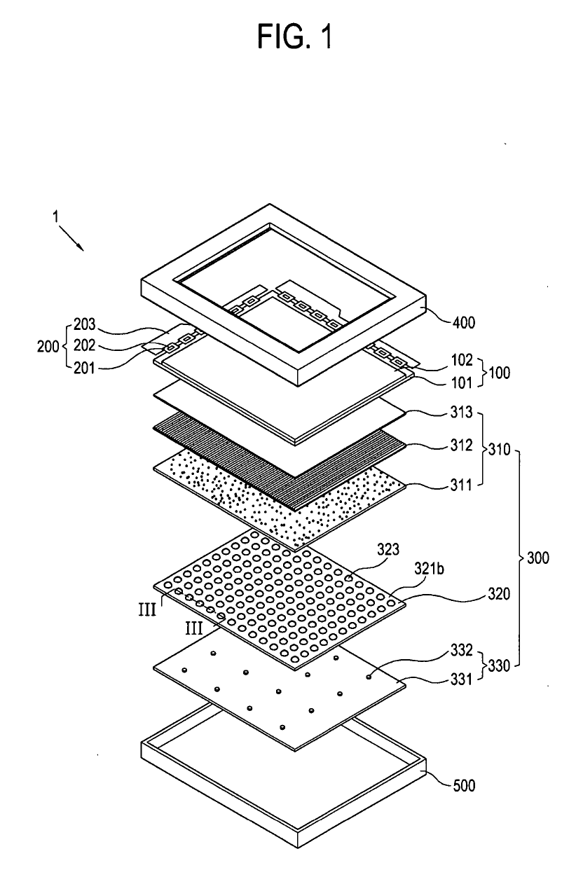

An exemplary embodiment of LCD device according to the present invention will be described with reference to FIGS. 1 to 4.

Referring to FIG. 1, a liquid crystal display (“LCD”) device 1 includes an LCD panel 100, a driver 200 which is connected to the LCD panel 100 and drives the LCD panel 100, and a backlight unit 300 disposed behind (e.g., facing a lower surface of) the LCD panel 100.

The LCD panel 100 and the backlight unit 300 are accommodated in an upper cover 400 and a lower cover 500. In an exemplary embodiment, the LCD panel 100 and the backlight unit 300 are received in the upper cover 400 and the lower cover 500. Inner surfaces of sidewalls of the upper cover 400 may face outer surfaces of sidewalls of the lower cover 500 when the upper and lower covers 400 and 500 are combined.

The LCD panel 100 includes a first substrate 101 including thin film transistors (not shown) formed thereon, a second substrate 102 facing the first substrate 101, a sealant (not shown) which bonds the substrates 101 and 102 together and maintains a cell gap between the first and second substrates 101 and 102, and a liquid crystal layer (not shown) disposed between the substrates 101 and 102 and the sealant.

The driver 200 includes a flexible printed circuit board (“FPCB”) 201, a driver chip 202 mounted on the FPCB 201 and a printed circuit board 203 connected to one side of the FPCB 201. The driver 200 may be connected to a peripheral portion of an exposed area of the first substrate 101 which is not covered by the second substrate 102. In the illustrated embodiment, the driver 200 shown in FIG. 1 is a chip on film (“COF”) type, but is not limited thereto. Any of a number of types of drivers, such as a tape carrier package (“TCP”), a chip on glass (“COG”), etc. may be used for the purpose described herein. In an exemplary embodiment, a portion of the driver 200 may be formed on the first substrate 101 during a wiring process.

The backlight unit 300 includes an optical film 310, an optical plate 320 and a light source 330 which may be disposed behind the LCD panel 100 in order, as illustrated in FIG. 1.

The optical film 310 may include a diffusion sheet 311, a prism sheet 312 and a protection sheet 313, but the optical film 310 is not limited thereto. The diffusion sheet 311, the prism sheet 312 and the protection sheet 313 may be disposed sequentially. The optical film 310 may include additional sheets or may exclude the diffusion sheet 311, the prism sheet 312 and/or the protection sheet 313.

The diffusion sheet 311 may include a base film (not shown) and a diffusion coating layer (not shown), such as formed on an entire or a portion of the base film. The diffusion sheet 311 diffuses incident light from the light source 330.

The prism sheet 312 may include triangular prisms formed in a predetermined arrangement thereon and allows light passing through the diffusion sheet 311 to progress perpendicularly towards the LCD panel 100, thereby improving brightness.

The protection sheet 313 reduces or effectively prevents external impact or infiltration of impurities from damaging the diffusion sheet 311 and the prism sheet 312. The protection sheet 313 essentially protects the diffusion sheet 311 and the prism sheet 312 which are vulnerable to the impurities, such as dust or scratches.

The optical plate 320 changes a distribution of light incident from the light source 330 and provides it to the diffusion sheet 311. In an exemplary embodiment, the optical plate 320 may include acrylic resin and a structure of the optical plate 320 will be later described further.

The light source 330 includes a light emitting diode (“LED”) circuit board 331 and LEDs 332 mounted on the LED circuit board 331.

In an exemplary embodiment, the LED circuit board 331 may be made of epoxy resin, ceramic or aluminum. A wire (not shown) to supply power to the LEDs 332 may be formed on the LED circuit board 331.

The LEDs 332 may be arranged on the LED circuit board 331 substantially in a matrix format, such as in a 3 by 4 matrix form a illustrated in FIG. 1. In the exemplary embodiment, a cover lens, which may be formed on the LEDs 332 to adjust brightness distribution of the LEDs 332, is omitted.

A reflection plate (not shown) may be disposed on the LED circuit board 331. An opening may be formed in the reflection plate to expose the LEDs 332.

While a single LED circuit board 331 is illustrated in FIG. 1, the present invention is not limited thereto. Alternatively, the LED circuit board 332 may be provided in plural.

Hereinafter, the optical plate 320 is explained in detail with reference to FIGS. 1 to 4.

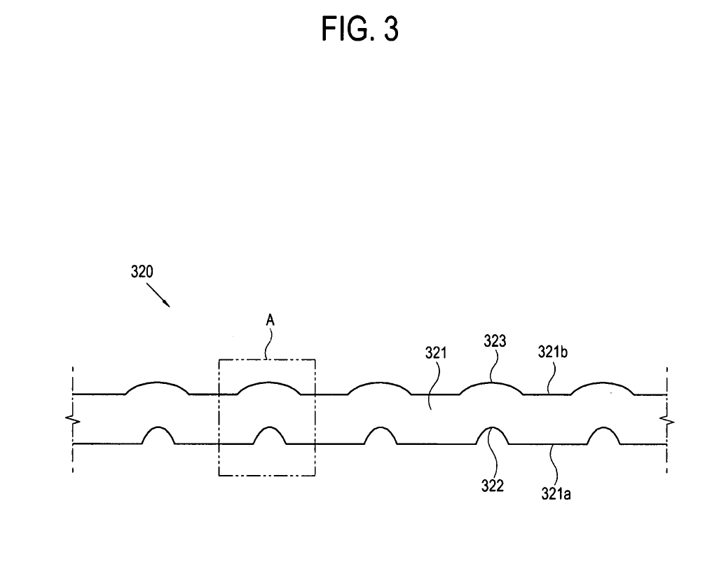

Referring to FIG. 3, the optical plate 320 includes a plate body 321, a first lens pattern 322 depressed into a first surface 321a (e.g., a lower surface) of the plate body 321, and a second lens pattern 323 projected from a second surface 321b (e.g., an upper surface) of the plate body 321. The first lens pattern 322 may be considered as concave portions of the optical plate 320, and the second lens pattern 323 may be considered as convex portions of the optical plate 320.

The first lens pattern 322 and the second lens pattern 323 correspond to each other. As illustrated in FIG. 3, each of the second protruding lens patterns 323 is disposed over a depressed one of the first lens pattern 322. As used herein, the first and second lens patterns 322 and 323 may be considered as “corresponding” substantially in shape, dimension and/or positional placement relative to each other.

Referring to FIGS. 1-3, each of the first and second lens patterns 322 and 323 are disposed in rows and columns. The rows extend in a transverse direction of the optical plate 320 and are arranged in a longitudinal direction of the optical plate 320. The columns extend in the longitudinal direction and are arranged in the transverse direction.

A plurality of the protruded portions of the second lens pattern 323 is aligned, from a front side (FIG. 1) of the optical sheet 320, in the rows and the columns. A plurality of the depressed portions of the first lens patterns 323 are aligned from a rear side (FIG. 3) of the optical sheet 320, in the rows and the columns. Since the first and second lens patterns 322 and 323 correspond to each other in a direction of the thickness of the optical plate 320, the rows and columns of the first and second lens patterns 322 and 323 also correspond to each other. The first and second lens patterns 322 and 323 are substantially uniformly spaced along the rows and columns, but the present invention is not limited thereto.

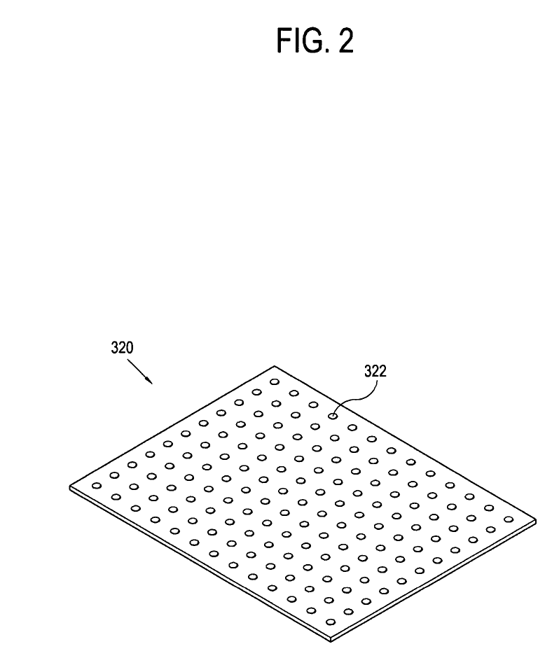

Referring to FIGS. 1 and 2, the first surface 321a of the plate body 321 faces to the light source 330, and the first lens pattern 322 faces to the light source 330. The second surface 321b of the plate body 321 faces to the diffusion sheet 311, and the second lens pattern 323 faces to the diffusion sheet 311.

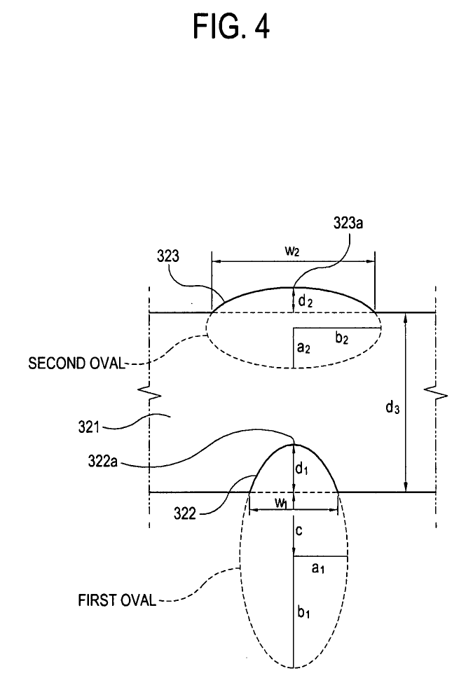

Referring to FIG. 4, an apex 322a of the depressed first lens pattern 322 and an apex 323a of the projected second lens pattern 323 are disposed to correspond to each other. The apexes 322a and 323a are positioned on a same axis which is perpendicular to a surface of the optical plate 320, such as a vertical axis perpendicular to the lower and/or upper surfaces of the optical plate 320.

The second lens pattern 323 is provided to be wider (e.g., in a horizontal direction of FIG. 3 or substantially parallel to the lower and/or upper surfaces of the optical plate 320) than the first lens pattern 322. That is, a diameter w2 of the second lens pattern 323 is larger than a diameter w1 of the first lens pattern 322. Accordingly, an area of the first lens pattern 322 is disposed within an area of the second lens pattern 323. The areas of the first and second lens patterns, 322 and 323 are taken in a plan view, such when viewing a plane substantially parallel to the lower and/or upper surfaces of the optical plate 320

The first lens pattern 322 is a part of a first oval, and the second lens pattern 323 is a part of a second oval. The first and second ovals in FIG. 4 are shown partially in a dotted line pattern and completed by a profile of the first and second lens patterns 322 and 323, respectively.

The first oval has a minor axis parallel with the optical plate 320. A minor radius a1 of the first oval is about 40% to about 60% of a major radius b1 of the first oval.

The second oval has a major axis parallel with the optical plate 320. A minor radius a2 of the second oval is about 10% to about 50% of the major radius b2 of the second oval. The minor radius a2 of the second oval is about 13% to about 23% of the major radius b1 of the first oval.

A depth d1 (e.g., height in a vertical direction) of the first lens pattern 322 is about 33% to about 43% of the major radius b1 of the first oval, which will be described later.

Meanwhile, a height d2 of the second lens pattern 323 is about 80% to about 100% of the minor radius a2 of the second oval.

In exemplary embodiments, a thickness d3 of the plate body 321 may be about 1.5 millimeters (mm) to about 2.5 millimeters (mm), the major radius b1 of the first oval may be about 1.95*0.95 mm (1.85 mm) to about 1.95*1.05 mm (2.05 mm), the depth d1 of the first lens pattern 322 may be about 0.75*0.95 mm (0.71 mm) to about 0.75*1.05 mm (0.79 mm), and/or the minor radius a2 of the second oval may be about 0.35*0.95 mm (0.33 mm) to about 0.35*1.05 mm (0.37 mm).

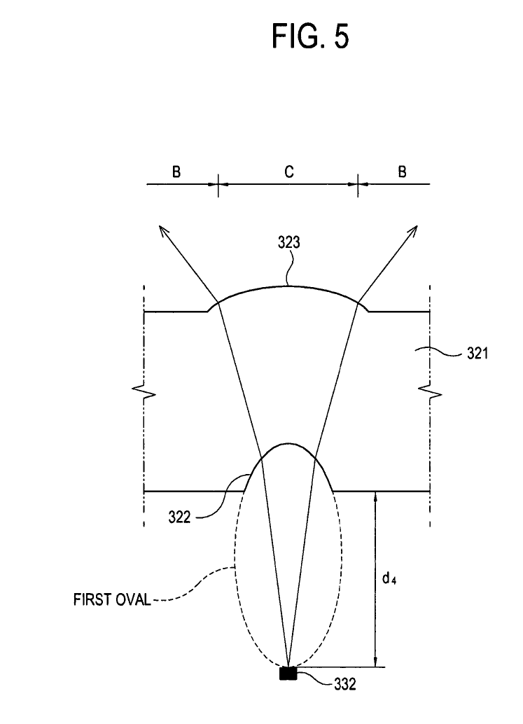

Referring to FIG. 5, an exemplary embodiment of a path of light emitted from the LEDs 332 will be described.

In the illustrated embodiment, since a cover lens is not provided on the LEDs 332 of the light source 330, a brightness distribution of light emitted from the LEDs 332 is similar in every direction. A light is incident comparatively more to an area C which the LEDs 332 are disposed directly below, and comparatively less to an area B between the LEDs 332.

The LEDs 332 are disposed below the minor axis of the first oval.

Light from the LEDs 332 is diffused through the first lens pattern 322 and once more diffused through the second lens pattern 323 and a light emitting surface of the optical plate 320, as indicated by the arrows in FIG. 5. The apexes 322a and 323a are extended into and from the optical plate 320, respectively, in a same direction as the light travels through the optical plate 320. Accordingly, the light which was diffused twice is not concentrated on the area C but dispersed to the area C and the area B.

Simulation according to the shape of the first lens pattern 322 and the shape of the second lens pattern 323 shows that brightness distribution of light through the optical plate 320 is significantly influenced by a ratio of the major radius b1 of the first oval to the depth d1 of the first lens pattern 322.

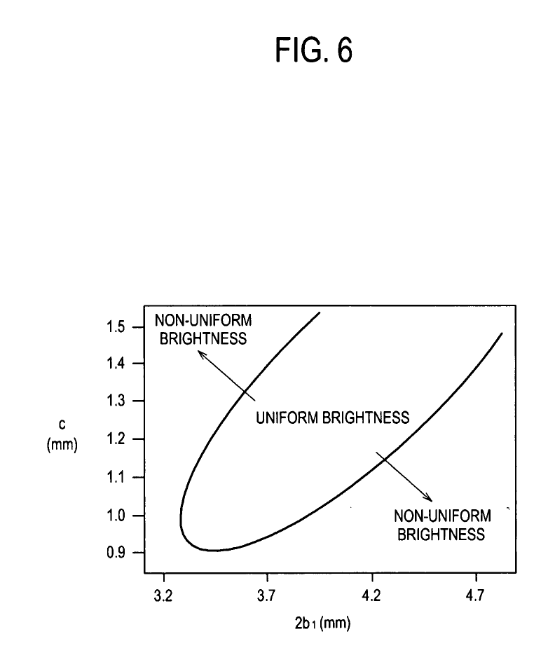

FIG. 6 shows an exemplary embodiment of brightness distribution according to the ratio of the major radius b1 of the first oval to the depth d1 of the first lens pattern 322.

In the simulation, a major diameter of the first oval, e.g., b1*2, and a distance between the minor axis of the first oval and the optical plate 320, e.g., c in FIG. 4, are variable. The depth d1 of the first lens pattern 322 is calculated by b1−c.

Referring to FIG. 6, when the ratio of the major radius b1 of the first oval to the depth d1 of the first lens pattern is kept in a predetermined value, the brightness uniformity is improved. When the ratio is out of the predetermined value, the brightness uniformity decreases.

The simulation illustrated in FIG. 6 shows that the brightness uniformity is excellent (e.g., uniform) when the depth d1 of the first lens pattern 322 is about 33% to about 43% of the major radius b1 of the first oval.

As in the illustrated embodiment, when the LCD device 1 includes the optical plate 320 with brightness uniformity, a display quality is improved and becomes superior. As the brightness uniformity is improved, fewer LEDs 332 may be used and/or an interval between the LEDs 332 may be increased, thereby reducing the cost. Also, a (e.g., vertical) distance d4 (FIG. 5) between the optical plate 320 and the LEDs 332 may be decreased, and the LCD may be made to be relatively thinner and slimmer.

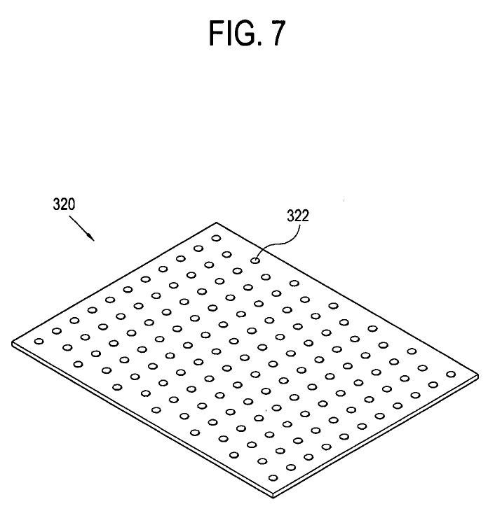

Hereinafter, another exemplary embodiment will be described with reference to FIG. 7. FIG. 7 is a perspective view of a back side of an optical plate for an LCD device. In the exemplary embodiment, first lens patterns 322 are arranged in a plurality of rows along a longitudinal direction of the optical plate 320, as in FIG. 3. However, the first lens patterns 322 in the respective rows are disposed crosswise each other along the longitudinal direction. That is, the first lens patterns 322 are not aligned in the columns, and are staggered relative to each other in adjacent rows.

Advantageously, if the first lens patterns 322 are disposed crosswise or alternating with each other in adjacent rows, more of the first lens patterns 322 can be formed in the same area. The first lens patterns 322 may be spaced closer to each other compared to the aligned column and row arrangement of FIG. 2, but the invention is not limited thereto. The first lens patterns 322 may be substantially uniformly spaced, or may be irregularly spaced relative to each other, such as along the longitudinal and/or the transverse directions of the optical plate 320.

Second lens patterns (not shown) are disposed to correspond to the first lens patterns 322. That is, the second lens patterns 323 are not aligned in the column direction, and are staggered relative to each other in adjacent rows.

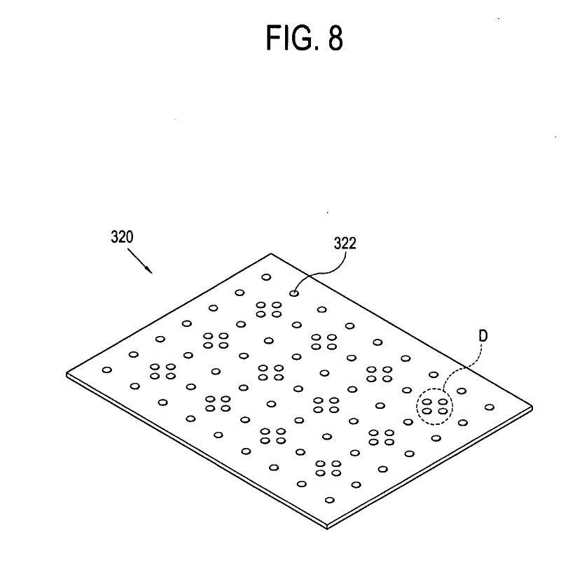

In the following, another exemplary embodiment will be described with reference to FIG. 8. FIG. 8 is a perspective view of a back side of an optical plate for an LCD device.

In the exemplary embodiment, first lens patterns 322 are densely disposed in an area D, which corresponds to LEDs 332 of the light source 330. Second lens patterns (not shown) are disposed to correspond to the first lens patterns 322. That is, a plurality of the second lens patterns are also grouped at a portion of the optical plate 320 corresponding to the LEDs 332 of the light source 330. While four LEDs 332 are illustrated in the denser area, the present invention is not limited thereto.

Rows of the first lens patterns 322 extend in a transverse direction of the optical plate 320 and are arranged in a longitudinal direction of the optical plate 320. Columns of the first lens patterns 322 extend in the longitudinal direction and are arranged in the transverse direction. The first lens patterns 322 densely group in the area D are alternately disposed along respective rows and columns.

A first row of the first lens patterns 322 in FIG. 8, may be considered as a row without the first lens patterns 322 densely disposed in the area D, such as odd-numbered rows. A second row of the first lens patterns 322 in FIG. 8, may be considered a row with the first lens patterns 322 densely disposed in the area D, such as even-numbered rows. The first and second rows are alternately arranged along a longitudinal direction of the optical plate 320.

Similarly, a first column of the first lens patterns 322 in FIG. 8, may be considered as a column without the first lens patterns 322 densely disposed in the area D, such as odd-numbered columns. A second column of the first lens patterns 322 in FIG. 8, may be considered a column with the first lens patterns 322 densely disposed in the area D, such as even-numbered columns. The first and second columns are alternately arranged along a transverse direction of the optical plate 320.

As illustrated in FIG. 8, the first lens patterns 322 may be considered as aligned along the columns. A different quantity of first lens patterns 322 are disposed in adjacent columns. The columns of the first lens patterns 322 are spaced apart from each other at varying distances along the transverse direction. The varying distances and quantities of the first prism patterns 322 provide a group of the first lens patterns 322 concentrated at a position corresponding to the LEDs 332 of the light source 330.

Similarly, the first lens patterns 322 may be considered as aligned along the rows. A different quantity of first lens patterns 322 are disposed in adjacent rows. The rows of the first lens patterns 322 are spaced apart from each other at varying distances along the longitudinal direction. The varying distances and quantities of the first prism patterns 322 provide a group of the first lens patterns 322 concentrated at a position corresponding to the LEDs 332 of the light source 330.

As in the illustrated embodiments, the present invention provides an optical plate which is improved in brightness uniformity and an LCD device having the same.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An optical plate comprising:
a plate body;
a first lens pattern depressed on a first surface of the plate body, the first surface being a light incident surface of the optical plate; and
a second lens pattern projected from a second surface of the plate body and corresponding to the first lens pattern, the second surface being a light emitting surface of the optical plate and an area of the first lens pattern being smaller than and included within an area of the second lens pattern.

2. The optical plate according to claim 1, wherein a longitudinal cross-section of the first lens pattern is a part of a first oval having a minor axis which is parallel with the first surface of the plate body.

3. The optical plate according to claim 2, wherein a longitudinal cross-section of the second lens pattern is a part of a second oval having a major axis which is parallel with the second surface of the plate body.

4. The optical plate according to claim 3, wherein a depth of the first lens pattern in a direction substantially perpendicular to the first surface of the plate body is about 33% to about 43% of a major radius of the first oval.

5. The optical plate according to claim 4, wherein a minor radius of the first oval is about 40% to about 60% of the major radius of the first oval.

6. The optical plate according to claim 5, wherein a minor radius of the second oval is about 13% to about 23% of the major radius of the first oval.

7. The optical plate according to claim 5, wherein a minor radius of the second oval is about 10% to about 50% of a major radius of the second oval.

8. A display device comprising:
a display panel;
a light source disposed behind the display panel and including a plurality of point light sources; and
an optical plate disposed between the display panel and the light source,
the optical plate comprising:
a plate body;
a first lens pattern depressed on a first surface of the plate body, the first surface of the plate body facing the light source; and
a second lens pattern projected from a second surface of the plate body and corresponding to the first lens pattern, the second surface of the plate body facing the display panel and an area of the first lens pattern being included within an area of the second lens pattern.

9. The display device according to claim 8, wherein a longitudinal cross-section of the first lens pattern is a part of a first oval and the first oval has a minor axis which is parallel with the first surface of the plate body.

10. The display device according to claim 9, wherein a depth of the first lens pattern is about 33% to about 43% of a major radius of the first oval.

11. The display device according to claim 9, wherein a longitudinal cross-section of the second lens pattern is a part of a second oval and the second oval has a major axis which is parallel with the second surface of the plate body.

12. The display device according to claim 11, wherein a minor radius of the first oval is about 40% to about 60% of the major radius of the first oval.

13. The display device according to claim 12, wherein a minor radius of the second oval is about 13% to about 23% of the major radius of the first oval.

14. The display device according to claim 13, wherein the minor radius of the second oval is about 10% to about 50% of a major radius of the second oval.

15. The display device according to claim 8, wherein the first lens pattern is disposed in a matrix form.

16. The display device according to claim 8, wherein the first lens pattern is arranged in a plurality of rows and adjacent rows of the first lens pattern are staggered.

17. The display device according to claim 8, wherein the first lens pattern is disposed more densely at an area of the optical plate corresponding to the point light sources.

18. The display device according to claim 9, wherein the minor axis of the first oval is disposed between the optical plate and the point light sources.
